(19) United States
(12) Patent Application Publication
(10) Pub. No.: US 2002/0086273 A1
(43) Pub. Date: Jul. 4, 2002

(54) Educational doll system

(76) Inventor: Kevin L. Haywood, Los Angeles, CA (US)

Correspondence Address: Kaardal & Associates, PC, Attn: Ivar M. Kaardal, Suite 250, 3500 South First Ave., Sioux Falls, SD, 57105-5802, US

(21) Appl. No.: 09/751,739

(22) Filed: Dec. 29, 2000

(51) Int. Cl. G09B 19/00

(52) U.S. Cl. 434/260

(57) ABSTRACT

An educational doll system for providing a friendly and safe educational aid to teach children how to dress and groom themselves. The educational doll system includes a doll with a head portion, a torso portion and a lower portion as well as a plurality of garments on the torso portion and lower portion of the doll; the garments include a plurality of fasteners designed for teaching children to fasten and undo the fasteners; and a backpack removably coupled to the torso portion of the doll, and having a pair of shoulder straps such that a shoulder of the torso portion of the doll is extended through one of the shoulder straps whereby the backpack is supported on a back of the torso portion of the doll.

### BACKGROUND OF THE INVENTION

1. Field of the Invention

The present invention relates to dolls and more particularly pertains to a new educational doll system for providing a friendly and safe educational aid to teach children how to dress and groom themselves.

2. Description of the Prior Art

The use of dolls is known in the prior art. More specifically, dolls heretofore devised and utilized are known to consist basically of familiar, expected and obvious structural configurations, notwithstanding the myriad of designs encompassed by the crowded prior art which have been developed for the fulfillment of countless objectives and requirements.

Known prior art includes U.S. Pat. Nos. 4,017,984; 4,911,670; U.S. Pat. No. Des. 312,558; U.S. Pat. No. Des. 245,930; U.S. Pat. Nos. 3,048,941; and 3,458,943.

While these devices fulfill their respective, particular objectives and requirements, the aforementioned patents do not disclose a new educational doll system. The inventive device includes a doll with a head portion, a torso portion and a lower portion as well as a plurality of garments on the torso portion and lower portion of the doll; the garments include a plurality of fasteners designed for teaching children to fasten and undo the fasteners; and a backpack removably coupled to the torso portion of the doll, and having a pair of shoulder straps such that a shoulder of the torso portion of the doll is extended through one of the shoulder straps whereby the backpack is supported on a back of the torso portion of the doll.

In these respects, the educational doll system according to the present invention substantially departs from the conventional concepts and designs of the prior art, and in so doing provides an apparatus primarily developed for the purpose of providing a friendly and safe educational aid to teach children how to dress and groom themselves.

### SUMMARY OF THE INVENTION

In view of the foregoing disadvantages inherent in the known types of dolls now present in the prior art, the present invention provides a new educational doll system construction wherein the same can be utilized for providing a friendly and safe educational aid to teach children how to dress and groom themselves.

The general purpose of the present invention, which will be described subsequently in greater detail, is to provide a new educational doll system apparatus and method which has many of the advantages of the dolls mentioned heretofore and many novel features that result in a new educational doll system which is not anticipated, rendered obvious, suggested, or even implied by any of the prior art dolls, either alone or in any combination thereof.

To attain this, the present invention generally comprises a doll with a head portion, a torso portion and a lower portion as well as a plurality of garments on the torso portion and lower portion of the doll; the garments include a plurality of fasteners designed for teaching children to fasten and undo the fasteners; and a backpack removably coupled to the torso portion of the doll, and having a pair of shoulder straps such that a shoulder of the torso portion of the doll is extended through one of the shoulder straps whereby the backpack is supported on a back of the torso portion of the doll.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new educational doll system apparatus and method which has many of the advantages of the dolls mentioned heretofore and many novel features that result in a new educational doll system which is not anticipated, rendered obvious, suggested, or even implied by any of the prior art dolls, either alone or in any combination thereof.

It is another object of the present invention to provide a new educational doll system which may be easily and efficiently manufactured and marketed.

It is a further object of the present invention to provide a new educational doll system which is of a durable and reliable construction.

An even further object of the present invention is to provide a new educational doll system which is susceptible of a low cost of manufacture with regard to both materials and labor, and which accordingly is then susceptible of low prices of sale to the consuming public, thereby making such educational doll system economically available to the buying public.

Still yet another object of the present invention is to provide a new educational doll system which provides in the apparatuses and methods of the prior art some of the advantages thereof, while simultaneously overcoming some of the disadvantages normally associated therewith.

Still another object of the present invention is to provide a new educational doll system for providing a friendly and safe educational aid to teach children how to dress and groom themselves.

Yet another object of the present invention is to provide a new educational doll system which includes a doll with a head portion, a torso portion and a lower portion as well as a plurality of garments on the torso portion and lower portion of the doll; the garments include a plurality of fasteners designed for teaching children to fasten and undo the fasteners; and a backpack removably coupled to the torso portion of the doll, and having a pair of shoulder straps such that a shoulder of the torso portion of the doll is extended through one of the shoulder straps whereby the backpack is supported on a back of the torso portion of the doll.

Still yet another object of the present invention is to provide a new educational doll system that provides children with a reassuring object which they can carry with them.

Even still another object of the present invention is to provide a new educational doll system that provides a lunch box.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic front view of a new educational doll system according to the present invention.

FIG. 2 is a schematic perspective view of the present invention.

FIG. 3 is a schematic perspective view of the backpack of the present invention.

FIG. 4 is a schematic cross-sectional side view of the present invention.

### DESCRIPTION OF THE PREFERRED EMBODIMENT

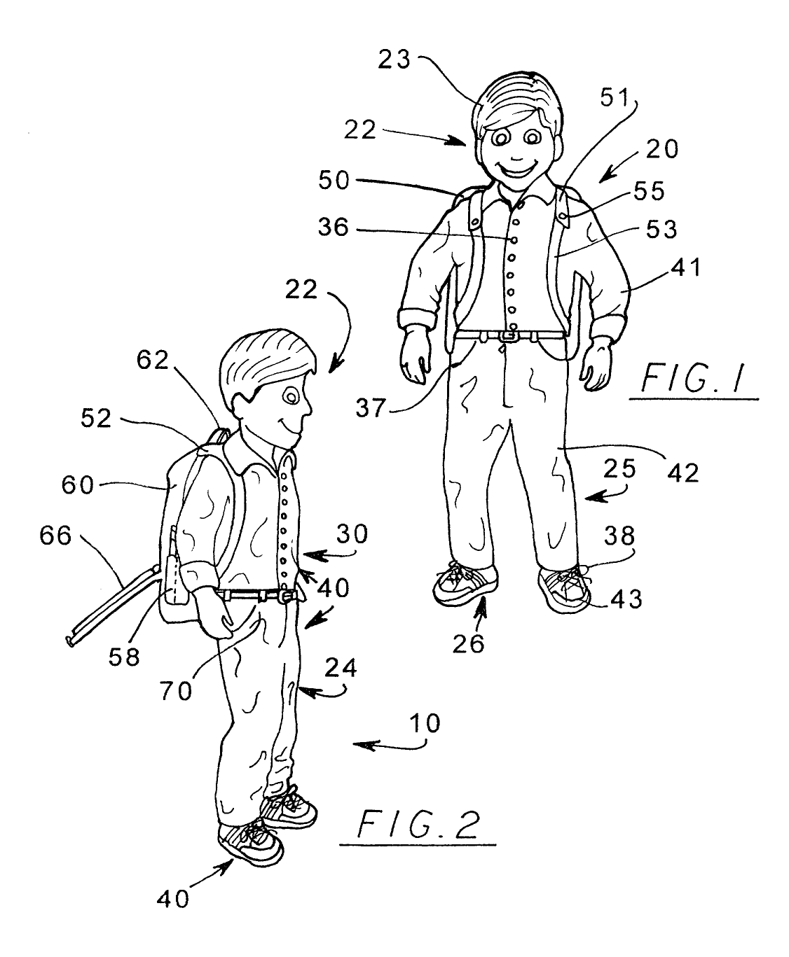

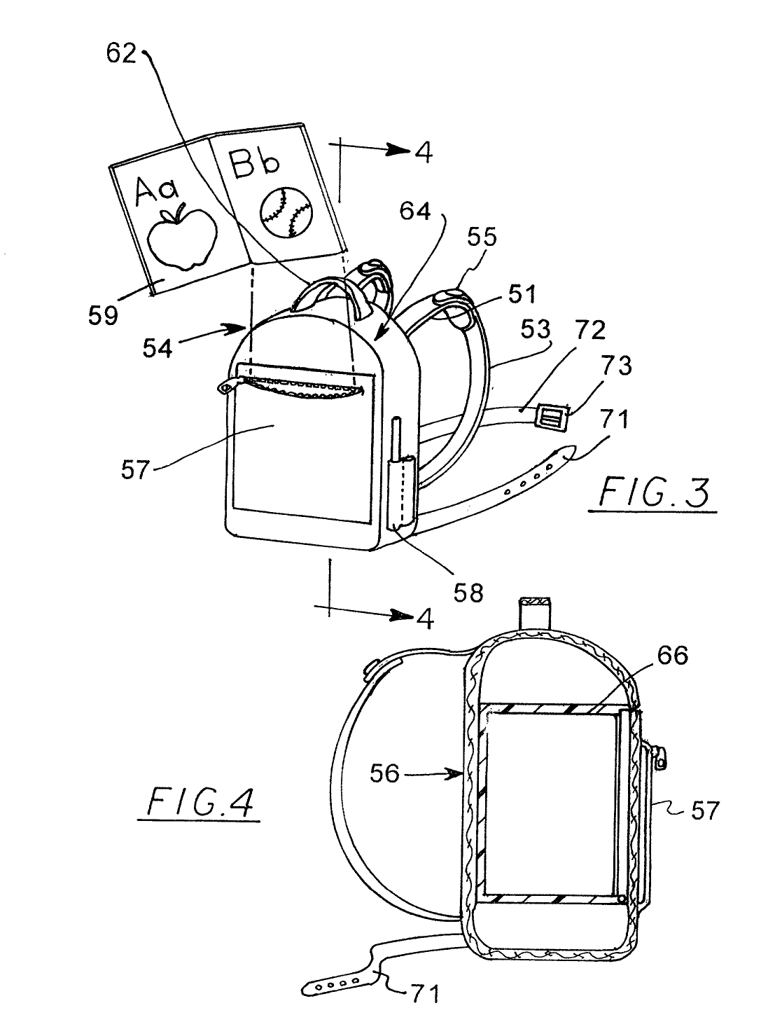

With reference now to the drawings, and in particular to FIGS. 1 through 4 thereof, a new educational doll system embodying the principles and concepts of the present invention and generally designated by the reference numeral 10 will be described.

As best illustrated in FIGS. 1 through 4, the educational doll system 10 generally comprises a doll 20, a backpack 50, and a belt 70.

The doll 20 includes a head portion 22, a torso portion 30 and a lower portion 24. The doll 20 includes a plurality of garments 40 on the torso portion 30 and the lower portion 24 of the doll 20. The garments 40 include a plurality of fasteners 35 coupled to the garments 40. The fasteners 35 are designed for teaching the child to fasten and undo the fasteners 35.

The backpack 50 is removably coupled to the torso portion 30 of the doll 20. The backpack 50 includes a pair of shoulder straps 52 such that a shoulder of the torso portion 30 of the doll 20 is extended through one of the shoulder straps 52. Thus the backpack 50 is supported on a back 32 of the torso portion 30 of the doll 20. The backpack 50 has a body portion 54. The shoulder straps 52 are coupled to a back surface 56 of the body portion 54 such that the back surface 56 of the body portion 54 lies adjacent to the back 32 of the torso region 30 of the doll 20.

In an embodiment the backpack 50 has at least one pocket 58 coupled to a side surface 60 of the body portion 54 of the backpack 50 such that the pocket 58 is designed for holding a pencil.

In a further embodiment the backpack 50 has a handle 62, which extends upward from an upper surface 64 of the body portion 54 of the back pack 50. The handle 62 of the backpack 50 is designed for aiding the child in carrying the backpack 50.

In yet a further embodiment the backpack 50 has a lunch box 66 positioned within an interior space of the body portion 54 of the backpack 50. The lunch box 66 includes a plurality of walls in a rectangular configuration. A front wall of the lunch box 66 is hingably coupled to a bottom wall of the lunch box 66 such that the front wall of the lunch box 66 extends outwardly from a front surface of the body portion 54 of the backpack 50 for permitting access to the lunch box 66 when the front wall is in an open position.

In still a further embodiment the front face of the body portion 54 of the backpack 50 includes a book pocket 57 positioned adjacent to the front wall of the lunch box 66. The book pocket 57 is designed for holding a book 59.

In still yet a further embodiment each of the shoulder straps 52 of the back pack 50 have a top member 51 and a bottom member 53. The bottom member 53 includes a portion of a snap fastener 55 and the top member 51 includes a complimentary portion of the snap fastener 55 such that the snap fastener 55 facilitates removal of the backpack 50 from the doll 20.

In an embodiment one of the garments 40 comprises a shirt 41 positioned on the torso portion 30 of the doll 20. A portion of the plurality of fasteners 35 are buttons 36 such that the shirt 41 is closeable by the buttons 36. Thus the child learns to put on a shirt by operating the buttons 36 and the shirt 41 of the doll 20.

In a further embodiment one of the garments 40 comprises a pair of pants 42 positioned on legs 25 of the lower portion 24 of doll 20. A portion of the plurality of fasteners 35 is a zipper fastener 37 positioned on the pair of pants 42 such that the zipper fastener 37 is designed for teaching the child to use the zipper 37 of the pair of pants 42 when the child is putting on the pair of pants 42.

In yet a further embodiment one of the garments 40 comprise a pair of shoes 43 positioned on feet 26 of the lower portion 24 of the doll 20. A portion of the plurality of fasteners 35 are laces 38 for lacing the shoes 43 closed. The laces 38 are designed for teaching the child to tie shoe laces.

In still a further embodiment the head portion 22 includes hair 23, which extends outwardly from the head portion 22. The hair 23 is designed for combing by the child to teach grooming to the child.

The belt 70 is coupled to the back 32 such that the belt 70 is securable around a waist of the doll 20. The belt 70 includes a first member 71 and a second member 72. The second member 72 includes a buckle 73 coupled to an end of the second member 72 such that the first member 71 is insertable through the buckle 73 of the second member 72 such that the first member 71 is secured to the second member 72 for securing around the waist of the doll 20.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An educational doll system for teaching basic skills to a child, said educational doll system comprising:
a doll having a head portion, a torso portion and a lower portion, said doll having a plurality of garments on said torso portion and said lower portion of said doll, said garments having a plurality of fasteners coupled to said garments, said fasteners being adapted for teaching the child to fasten and undo said fasteners; and
a backpack being removably coupled to said torso portion of said doll, said backpack having a pair of shoulder straps such that a shoulder of said torso portion of said doll is extended through one of said shoulder straps whereby said backpack is supported on a back of said torso portion of said doll.

2. The educational doll system as set forth in claim 1, wherein said backpack has a body portion, said shoulder straps being coupled to a back surface of said body portion such that said back surface of said body portion lies adjacent to said back of said torso region of said doll.

3. The educational doll system as set forth in claim 2, wherein said backpack has at least one pocket coupled to a side surface of said body portion of said backpack such that said pocket is adapted for holding a pencil.

4. The educational doll system as set forth in claim 2, wherein said backpack has a handle upwardly extending from an upper surface of said body portion of said back pack, said handle of said backpack being adapted for aiding the child in carrying said backpack.

5. The educational doll system as set forth in claim 2, wherein said backpack has a lunch box positioned within an interior space of said body portion of said backpack, said lunch box having a plurality walls in a rectangular configuration, a front wall of said lunch box being hingably coupled to a bottom wall of said lunch box such that said front wall of said lunch box extends outwardly from a front surface of said body portion of said backpack for permitting access to said lunch box when said front wall is in an open position.

6. The educational doll system as set forth in claim 5, wherein said front face of said body portion of said backpack having a book pocket positioned adjacent to said front wall of said lunch box, said book pocket being adapted for holding a book.

7. The educational doll system as set forth in claim 1, wherein each of said shoulder straps of said back pack have a top member and a bottom member, said bottom member having a portion of a snap fastener and said top member having a complimentary portion of said snap fastener such that said snap fastener facilitates removal of said backpack from said doll.

8. The educational doll system as set forth in claim 1, wherein one of said garments comprises a shirt positioned on said torso portion of said doll, a portion of said plurality fasteners comprising buttons such that said shirt is closeable by said buttons whereby the child learns to put on a shirt by operating said buttons and said shirt of said doll.

9. The educational doll system as set forth in claim 1, wherein one of said garments comprises a pair of pants positioned on legs of said lower portion of doll, a portion of said plurality of fasteners being a zipper fastener positioned on said pair of pants such that said zipper fastener is adapted for teaching the child to use said zipper of said pair of pants when the child is putting on a pair of pants.

9. The educational doll system as set forth in claim 1, wherein one of said garments comprise a pair of shoes positioned on feet of the lower portion of said doll, a portion of said plurality of fasteners being laces for lacing said shoes closed, said laces being adapted for teaching the child to tie shoe laces.

10. The educational doll system as set forth in claim 1, wherein said head portion having hair extending outwardly from said head portion, said hair being adapted for combing by the child to teach grooming to the child.

12. The educational doll system as set forth in claim 1, further comprising:
a belt coupled to said back such that said belt is securable around a waist of said doll, said belt having a first member and a second member, said second member having a buckle coupled to an end of said second member such that said first member is insertable through said buckle of said second member such that said first member is secured to said second member for securing around the waist of said doll.

13. An educational doll system for teaching basic skills to a child, said educational doll system comprising:
a doll having a head portion, a torso portion and a lower portion, said doll having a plurality of garments on said torso portion and said lower portion of said doll, said garments having a plurality of fasteners coupled to said garments, said fasteners being adapted for teaching the child to fasten and undo said fasteners;
a backpack being removably coupled to said torso portion of said doll, said backpack having a pair of shoulder straps such that a shoulder of said torso portion of said doll is extended through one of said shoulder straps whereby said backpack is supported on a back of said torso portion of said doll, said backpack has a body portion, said shoulder straps being coupled to a back surface of said body portion such that said back surface of said body portion lies adjacent to said back of said torso region of said doll;
wherein said backpack has at least one pocket coupled to a side surface of said body portion of said backpack such that said pocket is adapted for holding a pencil;
wherein said backpack has a handle upwardly extending from an upper surface of said body portion of said back pack, said handle of said backpack being adapted for aiding the child in carrying said backpack;
wherein said backpack has a lunch box positioned within an interior space of said body portion of said backpack, said lunch box having a plurality walls in a rectangular configuration, a front wall of said lunch box being hingably coupled to a bottom wall of said lunch box such that said front wall of said lunch box extends outwardly from a front surface of said body portion of said backpack for permitting access to said lunch box when said front wall is in an open position;
wherein said front face of said body portion of said backpack having a book pocket positioned adjacent to said front wall of said lunch box, said book pocket being adapted for holding a book;
wherein each of said shoulder straps of said back pack have a top member and a bottom member, said bottom member having a portion of a snap fastener and said top member having a complimentary portion of said snap fastener such that said snap fastener facilitates removal of said backpack from said doll;
wherein one of said garments comprises a shirt positioned on said torso portion of said doll, a portion of said plurality fasteners comprising buttons such that said shirt is closeable by said buttons whereby the child learns to put on a shirt by operating said buttons and said shirt of said doll;
wherein one of said garments comprises a pair of pants positioned on legs of said lower portion of doll, a portion of said plurality of fasteners being a zipper fastener positioned on said pair of pants such that said zipper fastener is adapted for teaching the child to use said zipper of said pair of pants when the child is putting on a pair of pants;
wherein one of said garments comprise a pair of shoes positioned on feet of the lower portion of said doll, a portion of said plurality of fasteners being laces for lacing said shoes closed, said laces being adapted for teaching the child to tie shoe laces;
wherein said head portion having hair extending outwardly from said head portion, said hair being adapted for combing by the child to teach grooming to the child; and
a belt coupled to said back such that said belt is securable around a waist of said doll, said belt having a first member and a second member, said second member having a buckle coupled to an end of said second member such that said first member is insertable through said buckle of said second member such that said first member is secured to said second member for securing around the waist of said doll.
